(19) United States
(12) Patent Application Publication
(10) Pub. No.: US 2022/0398856 A1
(43) Pub. Date: Dec. 15, 2022

(54) METHOD FOR RECONSTRUCTION OF A FEATURE IN AN ENVIRONMENTAL SCENE OF A ROAD

(71) Applicant: Continental Automotive GmbH, Hannover (DE)

(72) Inventors: Dongbing Quan, Mianyang City (CN); Wu Qi, Chengdu City (CN); Chen Shengton, Chengdu City (CN); Xu LinKun, Chengdu City (CN)

(21) Appl. No.: 17/828,578

(22) Filed: May 31, 2022

Related U.S. Application Data
(63) Continuation of application No. PCT/EP2020/084678, filed on Dec. 4, 2020.

(30) Foreign Application Priority Data
Dec. 11, 2019 (DE) 10 2019 219 358.7

(51) Int. Cl. G06V 20/70; G06T 7/12; G06T 7/73; G06T 17/05; G06T 7/13; G06T 5/00; G06T 7/60; G06T 7/187; G06V 20/56

(52) U.S. Cl. CPC G06V 20/70; G06T 7/12; G06T 7/73; G06T 17/05; G06T 7/13; G06T 5/002; G06T 7/60; G06T 7/187; G06V 20/588; G06T 2207/10028; G06T 2207/30241; G06T 2207/20021; G06T 2207/30256; G06T 2207/20068; G06T 2210/56; G06V 2201/08

(57) ABSTRACT

In a method for reconstruction of a feature in an environmental scene of a road, a 3D point cloud of the scene and a sequence of 2D images of the scene are generated. A portion of candidates of 3D points of the 3D point cloud is identified by projecting the 3D points to each of the 2D images, determining a plurality of candidates of the 3D points of the 3D point cloud representing the feature by semantic segmentation in each of the images, projecting the candidates of the 3D points on a plane of the road in each of the 2D images, and selecting those candidates of the 3D points staying in a projection range on the road in each of the 2D images. The selected candidates of the 3D points are merged for determining estimated locations of the feature. The feature can be modeled by generating a fitting curve along the estimated locations.

### FIELD OF THE INVENTION

The embodiments relates to a method for reconstruction of a feature in an environmental scene of a road, in particular an object that is located in a plane above the road surface or near the road, for example a vertical feature such as guardrails.

### DESCRIPTION OF THE RELATED ART

Detecting and reconstructing features in a driving environment is the basic requirement for generating an exact road database that may be used for autonomous or robot-assisted driving. During the task of mapping a driving environment, such as a highway, features in the environment of a road or features located above the road have to be recognized and modeled. In particular, vertical features, i.e. features/objects which are located in a plane vertically above the road, such as guardrails or others, must be identified for reconstruction/modeling.

A guardrail, for example, can be identified in a 3D space by sensors that provide depth information. According to a conventional method, a 3D point cloud may be generated from a LIDAR or radar system. Points on a guardrail can be selected by semantic segmentation. In a last step, the guardrail can be modeled through the selected points.

Vertical features, such as a guardrail, are very important parts of a HD 3D map. Traditional approaches to identify and model those features are based on using special vehicles with expensive equipment, such as the above-mentioned LIDAR and radar systems. It is basically easy to get a lot of well-positioned 3D points on the guardrail with such equipment, and easy to model. However, if low-cost equipment as it is used in series customer vehicles, such as a monocular camera, is supposed to be used for mapping, it is difficult to reconstruct enough accurate points to reconstruct the vertical feature, for example the guardrail in 3D space. Approaches such as structure from motion can derive 3D information. However, these approaches have the disadvantage that the delivered results are often noisy.

### SUMMARY OF THE INVENTION

The problem to be solved by the invention is to provide a method for reconstruction of a feature in an environmental scene of a road that may be performed with high accuracy by a low-cost equipment.

Solutions of the problem are described in the independent claims. The dependent claims relate to further improvements of the invention.

An embodiment of a method for reconstruction/modeling of a feature in an environmental scene of a road that may be carried out with simple equipment, but nevertheless allows to model the feature with high precision, is specified in the independent claim.

In an embodiment of the method for reconstruction of a feature in an environmental scene of a road, a 3D point cloud of the scene and a sequence of 2D images of the scene are generated. In a next step, a portion of candidates of 3D points of the 3D point cloud are identified. The portion of candidates of 3D points are identified by the following steps.

In a first step, the 3D points of the 3D point cloud are projected to each of the 2D images. In a next step, a plurality of candidates of the 3D points of the 3D point cloud representing the feature to be reconstructed are determined by semantic segmentation in each of the images. In a next step, a projection range on both sides of the road is determined in each of the 2D images. Then, the determined candidates of the 3D points are projected on a plane of the road in each of the 2D images. In a following step, those candidates of the 3D points staying in the projection range are selected as the portion of the candidates of the 3D points in each of the images.

After having identified the portion of the candidates of the 3D points, the selected candidates of the 3D points are merged for determining estimated locations of the feature to be reconstructed. In a last step, the feature is modeled/reconstructed by generating a fitting curve along the estimated locations.

In an embodiment of the method for reconstruction of a feature in an environmental scene of a road, the feature, such as a guardrail, is identified and modeled through projection of points between different views, for example a 3D semi-dense point cloud, 2D images that may be captured, for example, from a forward-facing camera, and a top-view representation. In this way, candidate points can be selected and confirmed to be part of the feature to be reconstructed, for example the guardrail, and then can be located for subsequent 3D modeling of the feature.

With the 3D point cloud that may be constructed as a semi-dense point cloud, and the semantic segmentation of the 2D images captured by an optical sensor, such as a forward-facing camera, rough candidate 3D points located on the feature can be selected first, by projection of related 3D points to each of the 2D camera images and selecting those of the candidate 3D points located in the region of the feature/object to be constructed, for example in a guardrail region. The selected candidates of the 3D points are potentially part of the feature to be reconstructed.

In a subsequent step, those of the rough candidate 3D points may be segmented/identified that are truly part of the feature to be reconstructed. Moreover, any noisy points may be removed as they would lead to a reconstruction of the feature, for example a guardrail, with the wrong depth.

Additional features and advantages are set forth in the detailed description that follows. It is to be understood that both the foregoing general description and the following detailed description are merely exemplary, and are intended to provide an overview or framework for understanding the nature and character of the claims.

### DESCRIPTION OF THE DRAWINGS

In the following the invention will be described by way of example, without limitation of the general inventive concept, on examples of embodiment with reference to the drawings.

FIG. 1 shows a flowchart illustrating method steps of a method for reconstruction of a feature in an environmental scene of a road;

FIG. 2 illustrates a 2D image of a scene captured by an optical sensor;

FIG. 3 illustrates a projection of 3D points of a 3D point cloud to a 2D image of a scene;

FIG. 4 shows candidates of 3D points of a 3D point cloud representing a feature in a scene;

FIG. 5 illustrates a projection range located on both sides of a road in a 2D image;

FIG. 6 illustrates a projection of candidates of 3D points on a road in a 2D image of a scene;

FIG. 7 illustrates a selection of valid candidates of 3D points for further processing to reconstruct a feature in an environmental scene of a road; and

FIG. 8 illustrates the reconstruction of a feature in an environmental scene of a road. FIG. 1 shows network nodes and a communication system according to be invention.

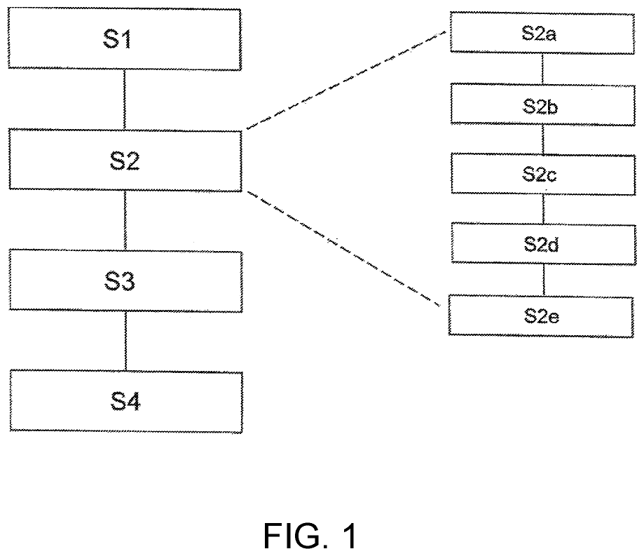

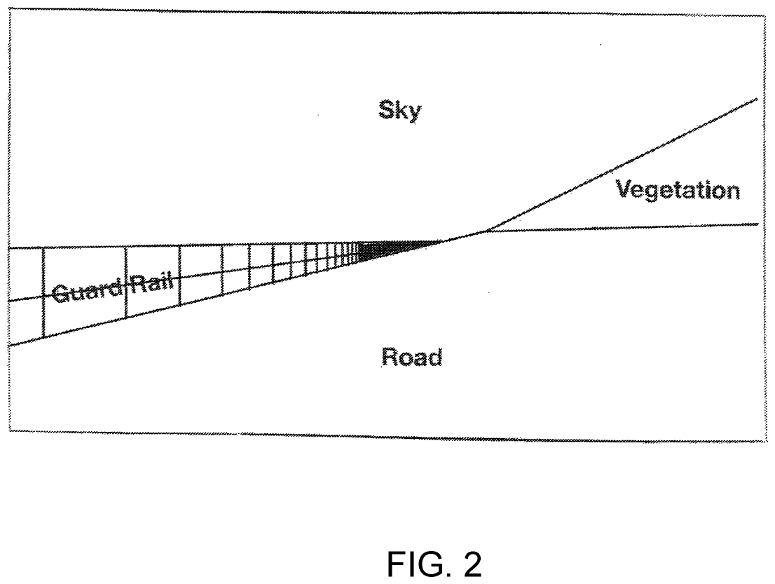

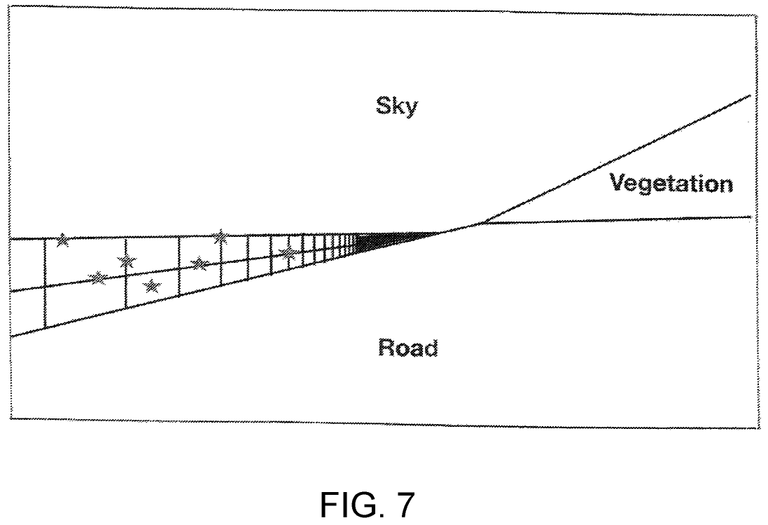

The method for reconstruction of a feature in an environmental scene is described in the following with reference to the block diagram of FIG. 1 illustrating the various method steps together with the remainder of the figures showing an illustrative example of a feature configured as a guardrail to be reconstructed by the proposed method. The FIGS. 2-7 illustrate the various steps of the method with reference to a 2D image of the scene. It has to be noted that the described steps have to be carried out in each of the images of a sequence of images captured from the scene.

In a first step S1 of the proposed method (FIG. 1), a sequence of 2D images of a scene is generated by an optical sensor, for example a camera, particularly a monocular camera. The sequence of the images may be captured by an optical sensor, such as a monocular camera, when moving the optical sensor through the scene. FIG. 2 shows an example of a 2D image of an environmental scene of a road captured by an optical sensor. The captured image comprises a road that is limited on the left side by a guardrail. Vegetation is located on the right side of the road. The upper portion of the image shows the sky over the road.

In the first step S1 of the proposed method, in addition to the generation of the sequence of the 2D images, a 3D point cloud of the scene is generated. The 3D point cloud may be construed as a semi-dense point cloud. In particular, the 3D point cloud may be generated during movement of an optical sensor along the road while capturing images of the environmental scene. It has to be noted that the proposed method is not limited to the use of a camera, particularly a monocular camera, for generating the 3D point cloud of the scene. The 3D point cloud may be generated by any other suitable sensor.

In method step S2, a portion of candidates of the 3D points of the 3D point cloud is identified. The step S2 comprises sub-steps S2a, S2b, S2c, S2d and S2e which are described in the following.

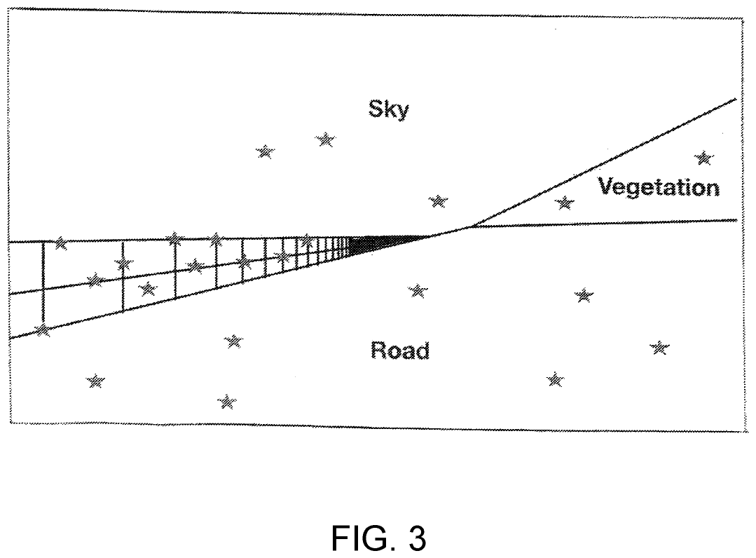

In sub-step S2a, the 3D points of the 3D point cloud are projected to each of the 2D images as illustrated in FIG. 3. The stars shown in FIG. 3 are projected points from a related 3D point cloud, for example a semi-dense point cloud, generated in step S1.

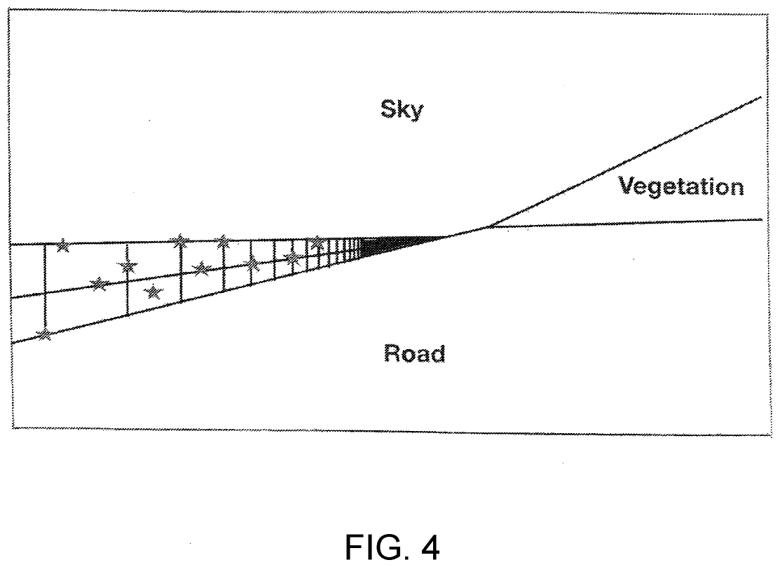

In the sub-step S2b, a plurality of candidates of the 3D points of the 3D point cloud representing the feature to be reconstructed, for example the guardrail, are determined by semantic segmentation in each of the 2D images. FIG. 4 illustrates the plurality of candidates of the 3D points shown in FIG. 3 which are determined and represent the guardrail on the left side of the road. In the sub-step S2b, a contour of the road and a contour of the feature, for example the guardrail, are determined from semantic segmentation in each of the 2D images. Moreover, in the sub-step S2b, borderlines of the road and borderlines of the feature, for example the guardrail, are identified, for example by using a least-square method. FIG. 4 illustrates the left and right borderlines of the road as well as the upper and lower borderlines of the guardrail to be reconstructed.

In a subsequent sub-step S2c, a projection range is determined on both sides of the road in each of the 2D images. In particular, the projection range is determined between a first boundary line and a second boundary line in each of the 2D images. The first boundary line is located at a first distance from one of the borderlines of the road. The second boundary line is located at a second distance from the same borderline of the road.

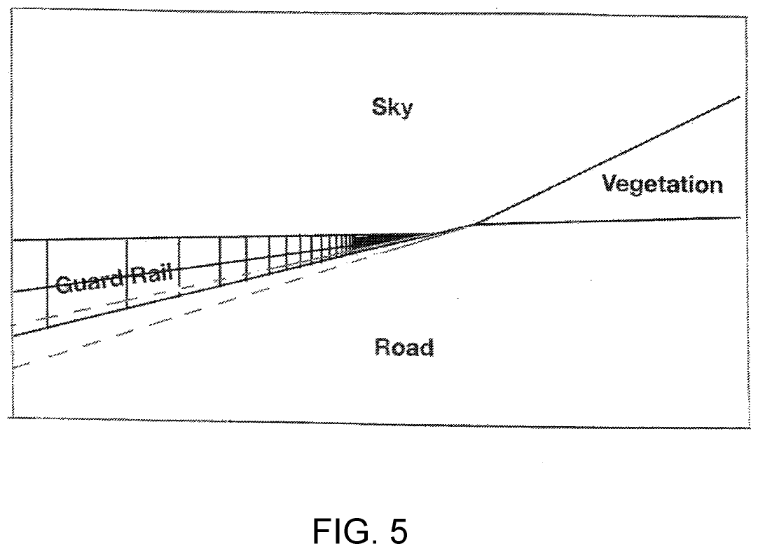

FIG. 5 illustrates the projection range located between a first boundary line and a second boundary line, as dashed lines. The first boundary line may be located, for example, 1 meter to the right of the left borderline of the road, and the second boundary line may be located 1 meter to the left of the left borderline of the road, when a feature/guardrail on the left side of the road is reconstructed by the proposed method.

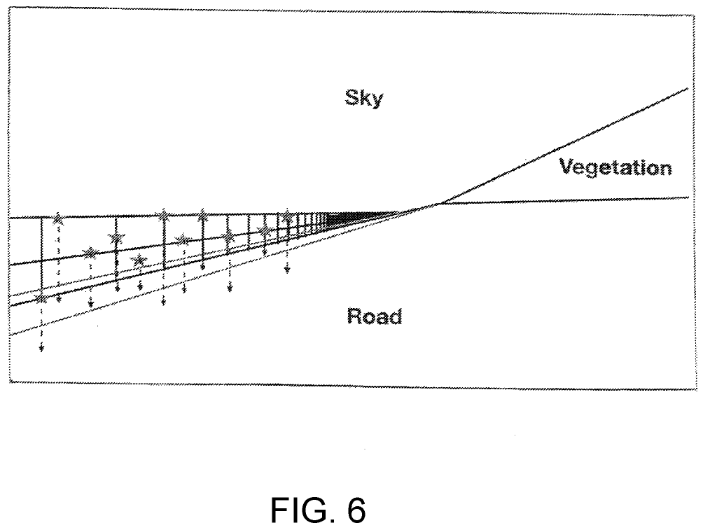

In the subsequent sub-step S2d, the candidates of the 3D points determined in the sub-step S2b are projected on a plane of the road in each of the 2D images. FIG. 6 illustrates the projection of the rough candidate 3D points on the road plane. The projected candidate 3D points are projected to the driver view camera image.

In the subsequent sub-step S2e, those candidates of the 3D points staying in the projection range are selected in each of the 2D images as the portion of the candidates of the 3D points used for the further processing described below. The selected portion of candidates of the 3D points represent the feature to be reconstructed with a higher probability than the plurality of candidates of the 3D points determined in sub-step S2b. Only those 3D points whose projections stay in the projection range are considered as being part of the feature to be reconstructed, for example the guardrail, and are kept for the further processing. The other ones of the plurality of candidates of the 3D points determined in the sub-step S2b are purged as noise.

In a step S3 following step S2, the selected candidates of the 3D points are merged for determining estimated locations of the feature to be reconstructed. In particular, in the step S3, a trajectory of a vehicle driving along the road is determined. The trajectory of the vehicle may be generated, for example, from a sequence of 2D camera images that are processed by a SLAM (Simultaneous Localization And Mapping) algorithm. The determined trajectory may be used as a reference.

The trajectory may be divided into a plurality of sections/bins. The bins may be determined by sampling the trajectory into uniform bins. In particular, the reference/trajectory can be sampled with the same distance to divide the trajectory into sorted uniform bins.

Then, the candidates of the 3D points selected in step S2e are assigned to a respective one of the plurality of bins. In particular, the selected candidates of the 3D points may be assigned to the respective one of the bins by applying a KNN (K-Nearest Neighbor) algorithm. The KNN algorithm may be used to look up the belonging bin for each candidate point's projection to the road plane.

In a last sub-step of step S3, a respective noise in each bin can be filtered to determine a respective one of the estimated locations of the feature to be reconstructed. The respective noise can be filtered by determining a respective centroid of the selected candidates of the 3D points assigned to the respective one of the plurality of bins. The respective centroid of each bin is considered as a respective one of the estimated locations of the feature to be reconstructed. The centroid of each bin can be used as the merged result being considered as a position of the feature to be reconstructed on the road surface.

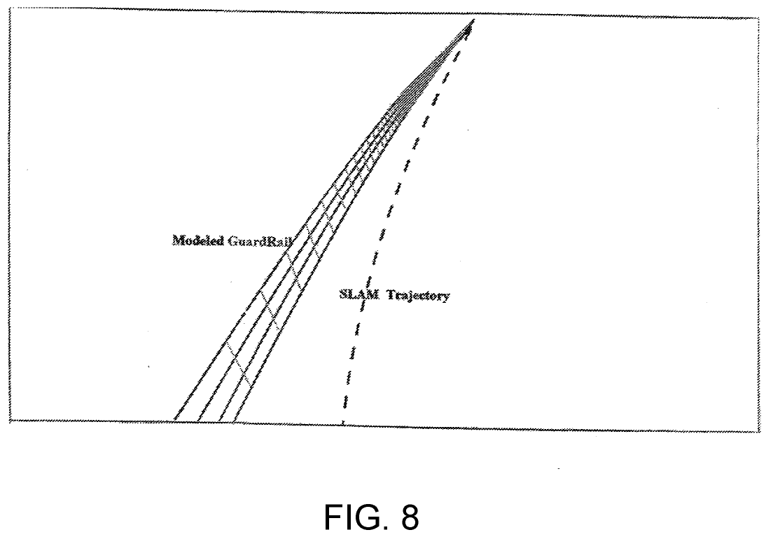

In the last step S4 of the proposed method the feature, for example the guardrail, is modeled by generating a fitting curve along the estimated locations determined in step S3. Moreover, the height of the feature above the road can also be modeled in step S4. FIG. 8 shows the reconstructed guardrail modeled by a curve (lowest line) with a height (vertical lines) and help lines for visualization (upper three lines of the guardrail).

In particular, the global noise can be filtered by applying a Gaussian algorithm, and all bins can be linked by Greedy Algorithm. The fitting curve can be modeled, for example by NURBS (Non-Uniform Rational B-Splines). The height of the feature to be reconstructed can be derived from one of the identified borderlines of the feature being above another one of the identified borderlines of the feature, for example from the upper borderline of the feature to be reconstructed, determined in the sub-step S2b.

The proposed method for reconstruction of a feature in an environmental scene of a road makes it possible to use a low-cost optical sensor, for example a monocular camera, for feature mapping, for example for guardrail mapping. The method allows to model features/particularly vertical features, i.e. features located in a plane vertically above a road surface or in the environment of the road, for example a guardrail, with a low number of 3D points. In particular, the proposed method allows the reconstruction of any objects which are perpendicular to a plane-surface of a road, for example a guardrail, a Jersey wall, curb, etc.

The method steps of the proposed method for reconstruction of a feature in an environmental scene of a road may be performed by a processor of a computer. In particular, the method for reconstruction of a feature in an environmental scene of a road may be implemented as a computer program product embodied on a computer readable medium. The computer program product includes instructions for causing the computer to execute the various method steps of the method for reconstruction of a feature in an environmental scene of a road.

1. A method for reconstruction of a feature in an environmental scene of a road, the method comprising:
generating a 3D point cloud of the scene and a sequence of 2D images of the scene;
identifying a portion of candidates of 3D points of the 3D point cloud by:
projecting 3D points of the 3D point cloud to each of the 2D images,
determining a plurality of candidates of the 3D points of the 3D point cloud representing the feature by semantic segmentation in each of the 2D images,
determining a projection range on both sides of the road in each of the 2D images,
projecting the candidates of the 3D points on a plane of the road in each of the 2D images,
selecting candidates of the 3D points staying in a projection range as selected candidates of the 3D points in each of the 2D images;
merging the selected candidates of the 3D points for determining estimated locations of the feature; and
modeling the feature by generating a fitting curve along the estimated locations.

2. The method of claim 1, comprising:
determining a contour of the road and a contour of the feature from the semantic segmentation in each of the 2D images.

3. The method of claim 1, comprising:
identifying border lines of the road and border lines of the feature.

4. The method of claim 3, comprising:
determining the projection range between a first boundary line and a second boundary line in each of the 2D images,
wherein the first boundary line is located at a first distance from one of the border lines of the road and the second boundary line is located at a second distance from said one of the border lines of the road.

5. The method of claim 1, wherein the 3D point cloud is construed as a semi-dense point cloud.

6. The method of claim 1, further comprising:
determining a trajectory of a vehicle driving along the road;
dividing the trajectory into a plurality of bins;
assigning the selected candidates of the 3D points to a respective one of the plurality of bins; and
filtering a respective noise in each bin of the plurality of bins to determine a respective one of the estimated locations of the feature.

7. The method of claim 6, wherein the bins are determined by sampling the trajectory into uniform bins.

8. The method of claim 6, wherein the selected candidates of the 3D points are assigned to the respective one of the bins by applying a K-Nearest Neighbor algorithm.

9. The method of claim 6, wherein the respective noise is filtered by determining a respective centroid of the selected candidates of the 3D points assigned to the respective one of the plurality of bins as the respective one of the estimated locations of the feature.

10. The method of claim 3, wherein a height of the feature is derived from one of the identified border lines of the feature being above another one of the identified border lines of the feature.

11. An apparatus comprising:
a non-transitory, machine-readable storage medium storing instructions; and
at least one processor coupled to the non-transitory, machine-readable storage medium, the at least one processor being configured to:
generate a 3D point cloud of a scene and a sequence of 2D images of the scene;
identify a portion of candidates of 3D points of the 3D point cloud by:
projecting 3D points of the 3D point cloud to each of the 2D images,
determining a plurality of candidates of the 3D points of the 3D point cloud representing a feature by semantic segmentation in each of the 2D images,
determining a projection range on both sides of the road in each of the 2D images,
projecting the candidates of the 3D points on a plane of the road in each of the 2D images,
selecting candidates of the 3D points staying in a projection range as selected candidates of the 3D points in each of the 2D images;
merge the selected candidates of the 3D points for determining estimated locations of the feature; and
model the feature by generating a fitting curve along the estimated locations.

12. The apparatus of claim 11, wherein the at least one processor is further configured to:
determine a contour of the road and a contour of the feature from the semantic segmentation in each of the 2D images.

13. The apparatus of claim 11, wherein the at least one processor is further configured to:
identify border lines of the road and border lines of the feature.

14. The apparatus of claim 11, wherein the at least one processor is further configured to:
determine the projection range between a first boundary line and a second boundary line in each of the 2D image, the first boundary line is located at a first distance from one of the border lines of the road and the second boundary line is located at a second distance from said one of the border lines of the road.

15. The apparatus of claim 11, wherein the 3D point cloud is construed as a semi-dense point cloud.

16. The apparatus of claim 11, wherein the at least one processor is further configured to:
determine a trajectory of a vehicle driving along the road;
divide the trajectory into a plurality of bins;
assign the selected candidates of the 3D points to a respective one of the plurality of bins; and
filter a respective noise in each bin of the plurality of bins to determine a respective one of the estimated locations of the feature.

17. The apparatus of claim 16, wherein the bins are determined by sampling the trajectory into uniform bins.

18. The apparatus of claim 16, wherein the selected candidates of the 3D points are assigned to the respective one of the bins by applying a K-Nearest Neighbor algorithm.

19. The apparatus of claim 16, wherein the respective noise is filtered by determining a respective centroid of the selected candidates of the 3D points assigned to the respective one of the plurality of bins as the respective one of the estimated locations of the feature.

20. A non-transitory, machine-readable medium having stored thereon a plurality of executable instructions, that when executed by a processor, the plurality of instructions comprising instructions to:
generate a 3D point cloud of the scene and a sequence of 2D images of the scene;
identify a portion of candidates of 3D points of the 3D point cloud by:
projecting 3D points of the 3D point cloud to each of the 2D images,
determining a plurality of candidates of the 3D points of the 3D point cloud representing the feature by semantic segmentation in each of the 2D images,
determining a projection range on both sides of the road in each of the 2D images,
projecting the candidates of the 3D points on a plane of the road in each of the 2D images,
selecting candidates of the 3D points staying in a projection range as selected candidates of the 3D points in each of the 2D images;
merge the selected candidates of the 3D points for determining estimated locations of the feature; and
model the feature by generating a fitting curve along the estimated locations.
